(19) United States
(12) Patent Application Publication
(10) Pub. No.: US 2021/0158595 A1
(43) Pub. Date: May 27, 2021

(54) INFORMATION PROCESSING APPARATUS, INFORMATION PROCESSING METHOD, AND INFORMATION PROCESSING SYSTEM

(71) Applicants: Mana AKAIKE, Tokyo (JP); Nobuyuki KISHI, Tokyo (JP); Atsushi ITOH, Kanagawa (JP)

(72) Inventors: Mana AKAIKE, Tokyo (JP); Nobuyuki KISHI, Tokyo (JP); Atsushi ITOH, Kanagawa (JP)

(21) Appl. No.: 17/102,564

(22) Filed: Nov. 24, 2020

(30) Foreign Application Priority Data
Nov. 25, 2019 (JP) 2019-212595
Jun. 30, 2020 (JP) 2020-113076

(51) Int. Cl. G06T 13/80; G06T 11/60; G06F 16/58; G06F 16/587

(52) U.S. Cl. CPC G06T 13/80; G06F 16/587; G06F 16/5866; G06T 11/60

(57) ABSTRACT

An information processing apparatus comprising circuitry configured to: determine an additional component to be added to a material image drawn on a medium; generate a modified image in which the determined additional component is added to the material image; and store the generated modified image.

### CROSS-REFERENCE TO RELATED APPLICATIONS

The present application claims priority under 35 U.S.C. § 119 to Japanese Patent Application No. 2019-212595, filed on Nov. 25, 2019 and Japanese Patent Application No. 2020-113076, filed on Jun. 30, 2020. The contents of which are incorporated herein by reference in their entirety.

### BACKGROUND OF THE INVENTION

### 1. Field of the Invention

The present invention relates to an information processing apparatus, an information processing method, and an information processing system.

### 2. Description of the Related Art

Conventionally, a system that reads, as image data, a picture drawn by an event participant at an event site, adds a movement to an image of the picture, and displays the image on a display device at the event site has been known. In the system, it is possible to cause images of pictures generated by a plurality of event participants to sequentially appear in a display region, and cause each of the images of the pictures to move around in the same display region. With this system, it is possible to further entertain the event participants at the event site and attract more customers, and therefore the system is used for promotion.

Japanese Unexamined Patent Application Publication No. 2016-177595 discloses a technology in which a movement is added to an image of a picture of, for example, a creature on the basis of feature data that is extracted from the image of the picture, the image of the picture is caused to move freely in a background (land, sea, or sky), and the image of the picture is projected and displayed by a projector.

However, in the conventional technology, the above-described entertainment is available only at the event site, and, although the participant has drawn the picture by him/herself, it is difficult to provide the participant with an opportunity to have such entertainment regardless of time, place, or the number of times.

### SUMMARY OF THE INVENTION

According to an aspect of the present invention, an information processing apparatus comprising circuitry configured to: determine an additional component to be added to a material image drawn on a medium; generate a modified image in which the determined additional component is added to the material image; and store the generated modified image.

### BRIEF DESCRIPTION OF THE DRAWINGS

FIG. 1 is a diagram illustrating an example of a configuration of an information processing system according to a first embodiment;

FIG. 2 is a diagram illustrating an example of a configuration of an image display system;

FIGS. 3A to 3D are diagrams illustrating examples of layout in paper;

FIG. 4 is a diagram illustrating an example of a hardware configuration of a content providing server;

FIG. 5 is a diagram illustrating an example of a functional block configuration of the content providing server;

FIG. 6 is a diagram illustrating an example of a hardware configuration of a terminal device;

FIG. 7 is a diagram illustrating an example of a sequence of a process of registering a material image or the like in the content providing server by a personal computer, which is installed in a store, in the information processing system;

FIG. 8 is a flowchart illustrating the flow of a modified image generation process performed by the content providing server;

FIG. 9 is a diagram illustrating an example of a top page;

FIG. 10 is a diagram illustrating an example of a modified image generation content;

FIG. 11 is a diagram illustrating another example of the modified image generation content;

FIG. 12 is a diagram illustrating an example of a modified image (stamp); and

FIG. 13 is a diagram illustrating an example of layout on paper according to a second embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment has an object to provide an opportunity to have entertainment based on a picture drawn by a participant regardless of time, place, or the number of times.

Embodiments of an information processing apparatus, an information processing method, and an information processing system will be described below with reference to the accompanying drawings.

### First Embodiment

In a first embodiment, one example of a mechanism that allows a terminal device of a participant to generate a modified image by adding an additional component to a material image that is displayable on an image display system, a configuration of an apparatus, and a method will be described. As one example, a case will be described in which a modified image (stamp) that is obtained by adding an additional component, such as a movement or decoration, to a picture (also referred to as a “drawn picture”) that a customer (hereinafter, referred to as an “event participant” or a “participant”) who has attended an event at a store or the like has generated on specified paper at the event site is provided to a terminal device of the participant.

Here, the “drawn picture” is a concept including a color-by-number. In the present embodiment, a “material drawn on a medium” includes not only an image drawn by an event participant, but also an image drawn by a staff person or the like. Further, a picture that is generated in advance, that is printed, or the like may be adopted, instead of the drawn picture. “Paper” is one example of a medium. The “medium” in the first embodiment is not limited to paper, but may be, for example, a medium on which a picture is drawn electronically or a medium on which a picture is drawn magnetically, as long as the medium can display a material.

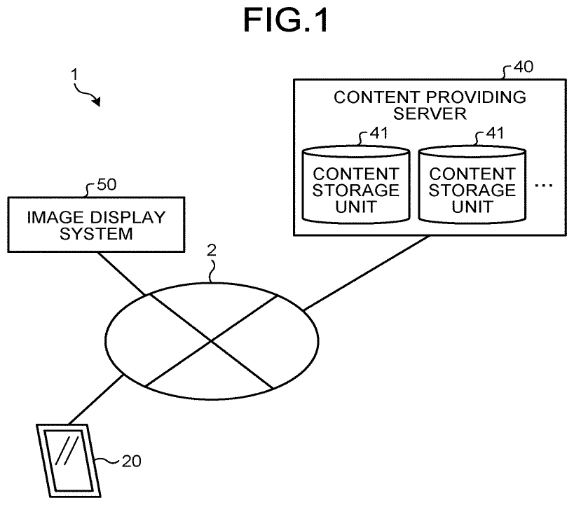

FIG. 1 is a diagram illustrating an example of a configuration of an information processing system 1 according to the first embodiment. As illustrated in FIG. 1, the information processing system 1 includes a terminal device 20, a content providing server 40 as a content server, an image display system 50, and the like. The terminal device 20, the content providing server 40 as an information processing apparatus, and the image display system 50 are connected to one another in a communicable manner via a network 2.

The network 2 is a local area network (LAN), a virtual private network (VPN), the Internet, or the like. The network 2 also appropriately connects an application providing server, an external service providing server, a social networking service (SNS) server, and the like in a communicable manner, in addition to the above-described devices.

Each of the terminal device 20 and the content providing server 40 is configured with a computer. Each of the devices may be configured such that a part or whole of the device is operated by dedicated hardware.

At an event site, a staff person (operator) generates image data by reading, by a scanner 55, paper on which an image (for example, a color-by-number of a creature or the like) is drawn by a participant, and thereafter, by the image display system 50, adds a movement to the image of the picture and displays the image.

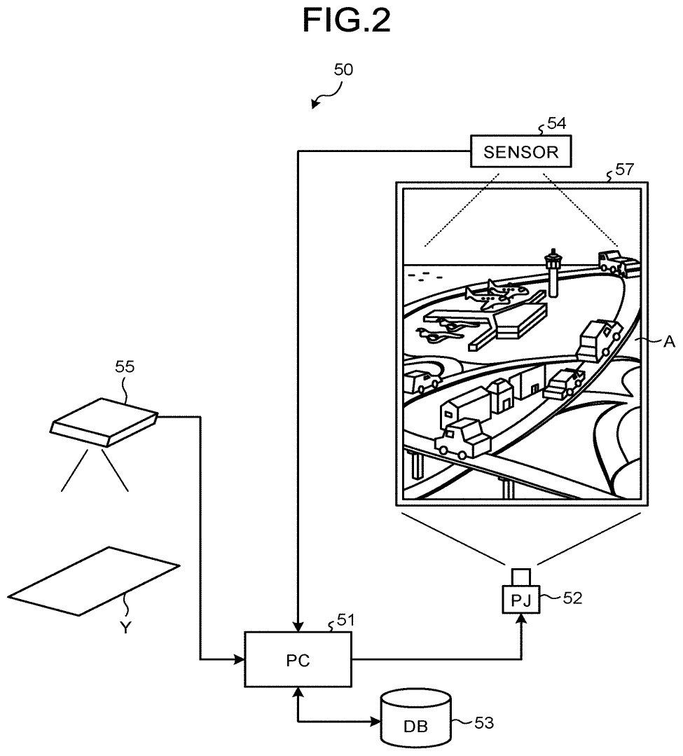

FIG. 2 is a diagram illustrating an example of a configuration of the image display system 50. In FIG. 2, the image display system 50 includes a personal computer (PC) 51, a projector (PJ) 52, an image database (DB) 53, a sensor 54, and the image reading apparatus (scanner) 55. Here, the image reading apparatus (scanner) 55 is the scanner 55 that is connected to the network 2 in FIG. 1, for example.

The image reading apparatus (scanner) 55 is one example of a “reading unit”. The image reading apparatus (scanner) 55 scans paper Y that is set at a predetermined position, and acquire an image (read image) of the paper Y. For example, the image reading apparatus 55 includes a scanner (imaging unit), a table on which the paper Y is placed, and a tool for fixing the scanner at a predetermined height with respect to the table. By setting the paper Y with the face up on the table and causing the scanner to optically scan a front surface of the paper Y, it is possible to read an image on the front surface of the paper Y.

The PC 51 controls entire operation of the image display system 50. The PC 51 acquires, as the read image, the paper Y on which a picture is drawn by an event participant at an event site from the image reading apparatus (scanner) 55, and registers the read image of the picture drawn on the paper Y in the DB 53.

The PC 51 extracts a material image, which serves as a material, from a predetermined region of the read image of the picture drawn by the participant, and registers the extracted material image in the DB 53. Further, the PC 51 analyzes the predetermined region of the read image of the picture drawn by the participant, and generates text data of an analysis result. The PC 51 registers the text data of the analysis result of the image in the DB 53. Further, the PC 51 transmits the material image and the text data, which are extracted from the read image of the picture drawn on the paper Y and which are registered in the DB 53, to the content providing server 40 at a predetermined timing.

Furthermore, the PC 51 sequentially generates display information A by adding a three-dimensional movement to the material image that is extracted from the read image of the picture drawn on the paper Y in the DB 53.

The PJ 52 projects the display information A to a projection medium 57 in accordance with a display signal output from the PC 51. The sensor 54 detects and outputs gestures, hand gestures, or the like of a person and the PC 51 updates a movement or the like of each of the pictures in accordance with output from the sensor 54. Meanwhile, the process performed by the PC 51 may be performed by a plurality of the PCs 51.

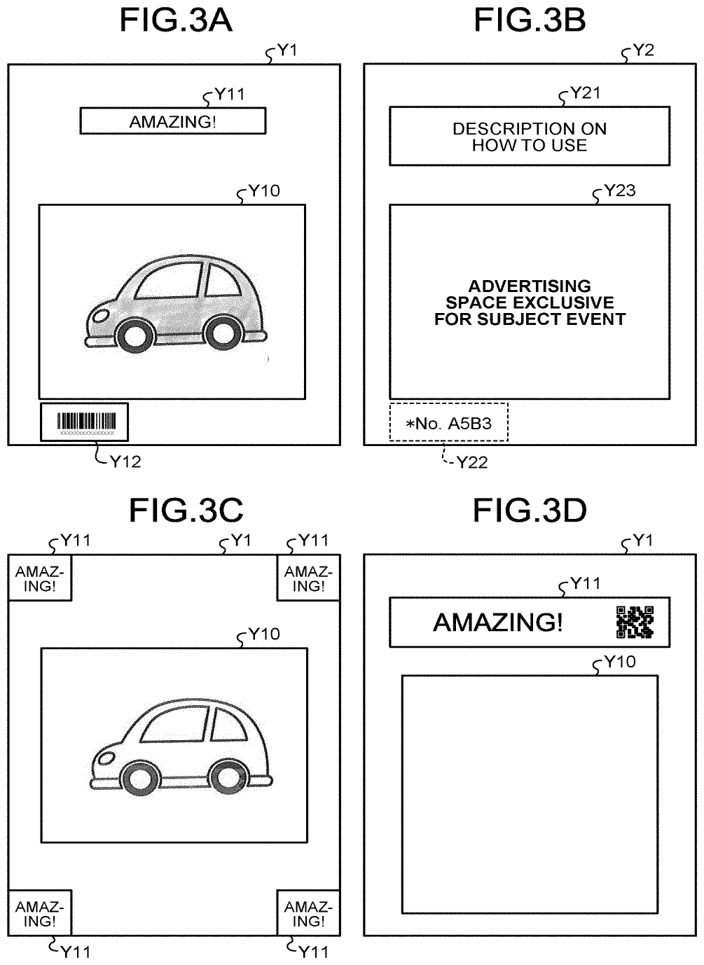

FIGS. 3A to 3D are diagrams illustrating examples of layout in the paper Y. The paper Y is paper that is distributed at the event site for use for picture drawing and. FIGS. 3A to 3D illustrate layout in each of a front surface Y1 and a back surface Y2 of the paper Y. An event participant draws a picture on the front surface Y1, and the image reading apparatus 55 reads an image on the front surface Y1. The back surface Y2 is mainly used when the participant acquires contents by the terminal device 20.

A handwriting region Y10 in which the event participant draws a picture in handwriting is arranged on the front surface Y1. In this example, a region Y11 for drawing a title of a picture in handwriting is also arranged. Furthermore, an identification region Y12 in which unique identification information is set is arranged on the front surface Y1. In FIGS. 3A to 3D, a barcode is illustrated as one example of the identification information. The identification information is information for identifying the paper Y.

The identification information may be a two-dimensional code (for example, a quick response (QR) code (registered trademark)). Further, the identification information may be an identification code including numerals, alphabets, symbols, and the like. Furthermore, the identification information may be other markers. Moreover, the identification region Y12 may include a color code or the like. In this manner, the identification information may be appropriately set in the identification region Y12. In addition, marks or the like for specifying orientation of the paper and arrangement of each of the regions in accordance with the setting may be arranged.

Meanwhile, the example has been described above in which the event participant draws a picture freehand in the handwriting region Y10, but as illustrated in FIG. 3C for example, it may be possible to prepare a sketch in the handwriting region Y10 and allows the event participant to color the sketch. Further, as for the identification region Y12, the same kind of or a plurality of kinds of identification information may be arranged at arbitrary positions on the front surface Y1 as illustrated in FIG. 3C and FIG. 3D.

A description region Y21 including descriptions of how to use a Web page to use the image drawn on the front surface Y1 is arranged in the back surface Y2. Further, an identification region Y22 in which the same identification information as the identification information set in the identification region Y12 on the front surface Y1 is arranged. In the identification region Y22, identification information including numerals, alphabets, symbols, and the like that can be read and input as keys to the terminal device 20 by a person is set.

Furthermore, an advertising region Y23 is arranged on the back surface Y2. In the advertising region Y23, an illustration of advertising of an event, text announcing the event, or the like can be set appropriately, for example.

Information in each of the regions in the paper Y can be set by performing printing, attaching a seal, or transcribing a URL that is arranged at an arbitrary location in the event site, or the like. In the following, explanation will be given on the assumption that each piece of information is printed.

The content providing server 40 generates a content to be used in a Web browser of the terminal device 20 on the basis of the material image, and registers the content in association with unique management information. In the present example, the material is an image of a picture in the handwriting region Y10, where the image is extracted from the image that is obtained by reading, by the scanner 55, the picture that the participant has drawn on the front surface Y1 of the paper.

The content providing server 40 generates a content that is available on a Web browser installed in the terminal device 20, on the basis of an image that is obtained by extracting the image of the picture in the handwriting region Y10 from the image of the picture that the participant has drawn on the front surface Y1 of the paper. A registration destination of the content is specified by management information, such as unique identification information, that is added to the paper on which the picture is drawn.

The terminal device 20 is an easily portable terminal device, such as a tablet computer or a smartphone. A user of the terminal device 20 may be, for example, an event participant, and if the event participant is a child, the user may be a family of the child. A Web browser is installed in the terminal device 20. The Web browser is an application that handles information resources on World Wide Webs (WWW). The Web browser is downloaded from a predetermined Web site (an application providing server or the like), and then installed. The Web browser need not always be provided through a Web site, but may be provided by a portable medium, such as a compact disk-read only memory (CD-ROM).

If the terminal device 20 activates the Web browser, the Web browser connects the terminal device 20 to the Internet. Accordingly, the terminal device 20 acquires a desired content from the content providing server 40 on the network 2 via the Web browser.

The content providing server 40 includes a content storage unit 41 for storing contents that are available on the Web browser of the terminal device 20, and provides a target content to the terminal device 20.

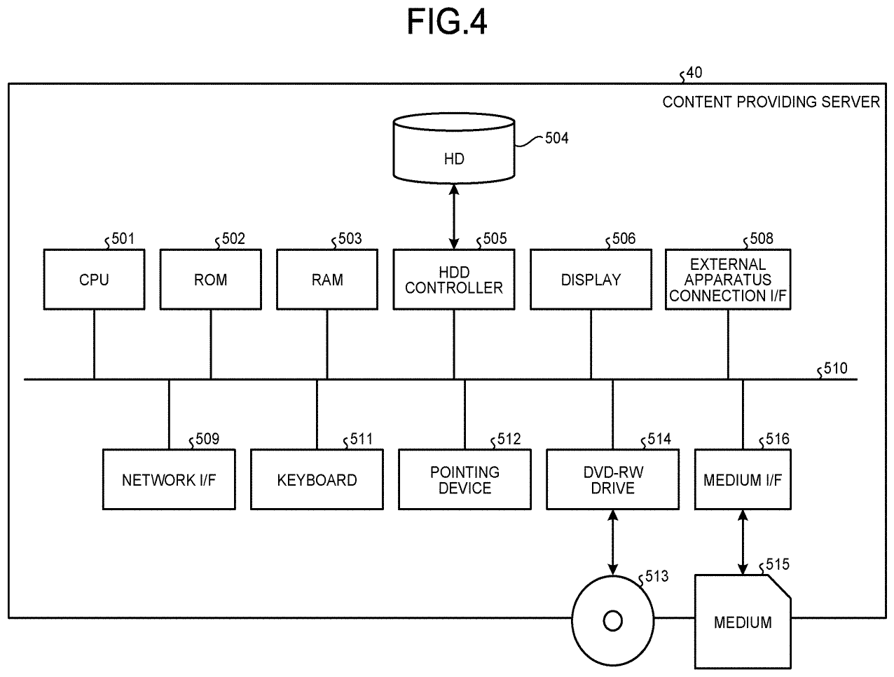

The content providing server 40 transmits the target content to the terminal device 20 via the network 2. The content is a Web page generated by the content providing server 40. Each of the contents is stored in a storage location (a destination from which the terminal device 20 acquires information) that is specified by the identification information that is associated in a hard disk (HD) 504 at the time of registration (see FIG. 4). Here, as one example, it is assumed that each of the contents is stored in a storage location that is indicated by a unique identification code (not illustrated) for each store. For example, each of the contents is classified into a hierarchy of directories, and registered at a file path that is specified by the identification code for each store. While the plurality of content storage units 41 are illustrated in this example, they are separated in accordance with types of contents or the like, for example. Each of the content storage units 41 is accessed through the path corresponding to each of the content providing servers 40.

Hardware Configuration of Content Providing Server 40

FIG. 4 is a diagram illustrating an example of a hardware configuration of the content providing server 40. The content providing server 40 includes a single or a plurality of computers, and, as illustrated in FIG. 4, includes a central processing unit (CPU) 501, a ROM 502, a random access memory (RAM) 503, a hard disk (HD) 504, a hard disk drive (HDD) controller 505, a display 506, an external apparatus connection interface (I/F) 508, a network I/F 509, a bus line 510, a keyboard 511, a pointing device 512, a digital versatile disk rewritable (DVD-RW) drive 514, and a media I/F 516.

Among the units as described above, the CPU 501 controls entire operation of the content providing server 40. The ROM 502 stores therein a program, such as initial program loader (IPL), that is used to drive the CPU 501. The RAM 503 is used as a work area of the CPU 501.

The HD 504 stores therein various kinds of data, such as a program. The HDD controller 505 controls read or write of various kinds of data with respect to the HD 504 under the control of the CPU 501.

The display 506 displays various kinds of information, such as a cursor, a menu, a window, a character, or an image. The external apparatus connection I/F 508 is an interface for connecting various external apparatuses. The external apparatuses in this case are, for example, universal serial bus (USB) memories, printers, or the like. The network I/F 509 is an interface for performing data communication using the network 2. The bus line 510 is an address bus, a data bus, or the like for electrically connecting the structural elements, such as the CPU 501, illustrated in FIG. 4.

Further, the keyboard 511 is a kind of an input unit provided with a plurality of keys for inputting characters, values, various instructions, and the like. The pointing device 512 is a kind of an input unit for selecting and executing various instructions, for selecting a processing target, for moving a cursor, or the like.

The DVD-RW drive 514 controls read or write of various kinds of data with respect to a DVD-rewritable (RW) 513 that is one example of a removable recording medium. The medium is not limited to the DVD-RW, but may be a DVD-recordable (DVD-R) or the like. The media I/F 516 controls read or write (storage) of data with respect to a recording medium 515, such as a flash memory.

The program executed by the content providing server 40 of the first embodiment is provided by being recorded in a computer-readable recording medium, such as a CD-ROM, a flexible disk (FD), a CD-R, or a DVD, in a computer-installable or a computer-executable file format.

Furthermore, the program executed by the content providing server 40 of the first embodiment may be stored in a computer connected to a network, such as the Internet, and may be provided by download via the network. Moreover, the program executed by the content providing server 40 of the first embodiment may be provided or distributed via a network, such as the Internet.

Furthermore, the program executed by the content providing server 40 of the first embodiment may be provided by being incorporated in a ROM or the like in advance.

Functional Configuration of Content Providing Server 40

Next, a content providing process as a characteristic process of the first embodiment among various kinds of arithmetic processing that are performed by the CPU 501 of the content providing server 40 in accordance with a program will be described below.

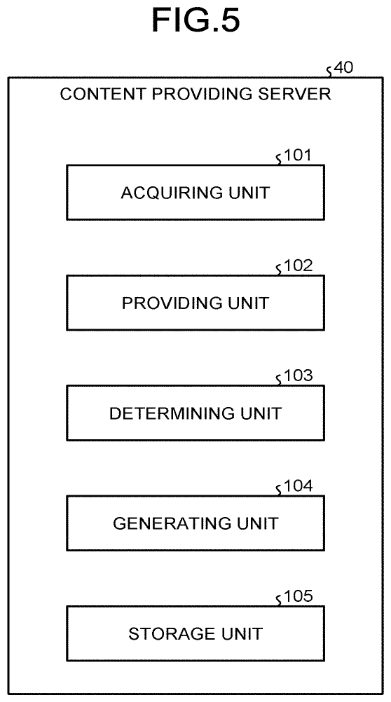

FIG. 5 is a diagram illustrating an example of a functional block configuration of the content providing server 40. In FIG. 5, the content providing server 40 includes an acquiring unit 101, a providing unit 102, a determining unit 103, a generating unit 104, and a storage unit 105. The functions of these units are implemented by circuitry represented by the content providing server 40.

The acquiring unit 101 acquires a material image that is drawn on a medium and that is output from the image display system 50 (an image of a picture drawn in the handwriting region Y10 in the image on the front surface Y1 of the paper. The same applies to the following).

The providing unit 102 provides the material image to the predetermined terminal device 20. More specifically, the providing unit 102 provides a content, which includes a material image and by which an additional component, such as a motion or decoration, can be added to the material image, to the predetermined terminal device 20. The content is a Web page that is made available to the Web browser of the terminal device 20.

The determining unit 103 determines an additional component that is to be added to a material image, via the Web browser of the terminal device 20.

The generating unit 104 generates a modified image in which the additional component determined by the determining unit 103 is added to the material image (the image obtained by extracting the image of the picture in the handwriting region Y10 from the image on the front surface Y1 of the paper).

The storage unit 105 stores the modified image generated by the generating unit 104 in the predetermined terminal device 20.

Hardware Configuration of Terminal Device 20

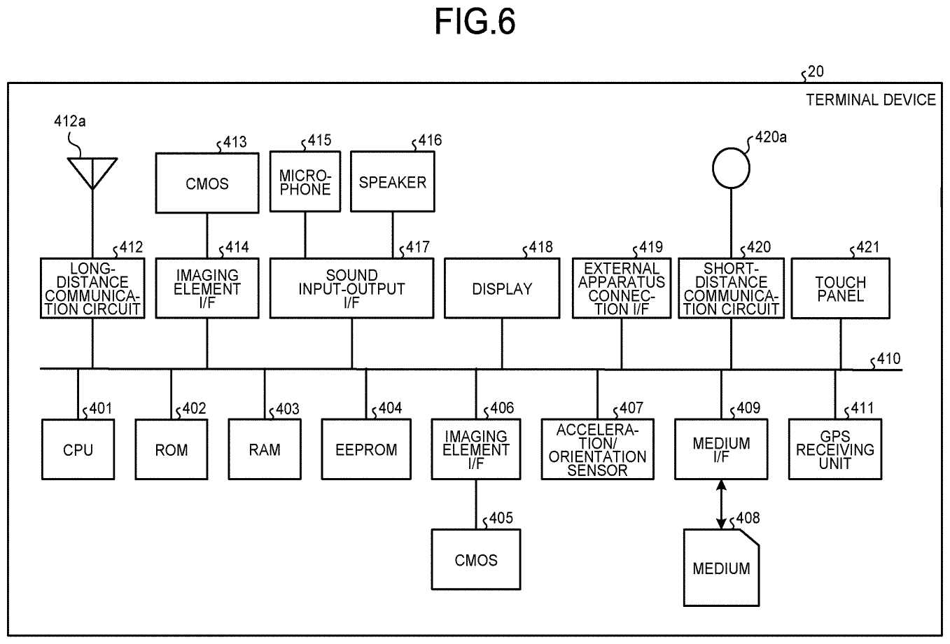

FIG. 6 is a diagram illustrating an example of a hardware configuration of the terminal device 20. The terminal device 20 is a smartphone. As illustrated in FIG. 6, the terminal device 20 includes a CPU 401, a ROM 402, a RAM 403, an electrically erasable programmable read-only memory (EEPROM) 404, a complementary metal oxide semiconductor (CMOS) sensor 405, an imaging element I/F 406, an acceleration/orientation sensor 407, a media I/F 409, and a global positioning sensor (GPS) receiving unit 411.

Among the units as described above, the CPU 401 controls entire operation of the terminal device 20. The ROM 402 stores therein a program that is used to drive the CPU 401 or the CPU 401 for an IPL or the like. The RAM 403 is used as a work area of the CPU 401. The EEPROM 404 reads or writes various kinds of data of a smartphone program, such as a Web browser, under the control of the CPU 401, for example.

The CMOS sensor 405 is one kind of a built-in imaging means that captures an image of an object (mainly, a self-portrait) and obtains image data under the control of the CPU 401. Meanwhile, the imaging means may be a charge coupler device (CCD) sensor or the like, instead of the CMOS sensor. The imaging element I/F 406 is a circuit that controls drive of the CMOS sensor 405.

The acceleration/orientation sensor 407 is various kinds of sensors, such as an electromagnetic compass that detects geomagnetism, a gyrocompass, or an acceleration sensor. The media I/F 409 controls read or write (storage) of data with respect to a recording medium 408, such as a flash memory. The GPS receiving unit 411 receives a GPS signal from a GPS satellite.

The terminal device 20 further includes a long-distance communication circuit 412, a CMOS sensor 413, an imaging element I/F 414, a microphone 415, a speaker 416, a sound input-output I/F 417, a display 418, an external apparatus connection I/F 419, a short-distance communication circuit 420, an antenna 420a of the short-distance communication circuit 420, and a touch panel 421.

Among the units as described above, the long-distance communication circuit 412 is a circuit that communicates with other apparatuses via a communication network 100. The CMOS sensor 413 is one kind of a built-in imaging means that captures an image of an object and obtains image data under the control of the CPU 401. The imaging element I/F 414 is a circuit that controls drive of the CMOS sensor 413.

The microphone 415 is a built-in circuit that converts sound to an electrical signal. The speaker 416 is a built-in circuit that converts the electrical signal to physical vibration and generates sound, such as music or voice. The sound input-output I/F 417 is a circuit that processes input and output of a sound signal between the microphone 415 and the speaker 416 under the control of the CPU 401.

The display 418 is one kind of a display means, such as liquid crystal or organic electro luminescence (EL), for displaying an image of the object, various icons, or the like. The external apparatus connection I/F 419 is an interface for connecting various external apparatuses. The short-distance communication circuit 420 is a communication circuit for short field communication (NFC), Bluetooth (registered trademark), or the like. The touch panel 421 is one kind of an input means that operates the terminal device 20 when a user presses the display 418.

The terminal device 20 further includes a bus line 410. The bus line 410 is an address bus, a data bus, or the like for electrically connecting each of the structural elements, such as the CPU 401, illustrated in FIG. 6.

A program, such as a Web browser, executed by the terminal device 20 of the first embodiment is provided by being recorded in a computer-readable recording medium, such as a CD-ROM, an FD, a CD-R, or a DVD, in a computer-installable or a computer-executable file format.

Furthermore, the program, such as a Web browser, executed by the terminal device 20 of the first embodiment may be stored in a computer connected to a network, such as the Internet, and may be provided by download via the network. Moreover, the program, such as a Web browser, executed by the terminal device 20 of the first embodiment may be provided or distributed via a network, such as the Internet.

Furthermore, the program, such as a Web browser, executed by the terminal device 20 of the first embodiment may be provided by being incorporated in a ROM or the like in advance.

System Operation

Various kinds of processing operation performed by the information processing system 1 will be described below.

Registration Process

First, an outline of a sequence for registering a material image or the like will be described below.

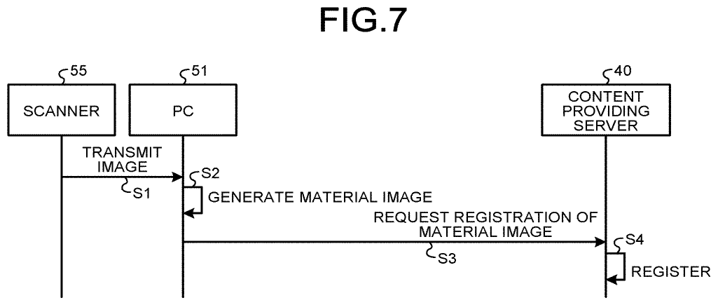

FIG. 7 is a diagram illustrating an example of a sequence of a process of registering a material image or the like in the content providing server 40 by the PC 51 of the image display system 50, which is installed in a store, in the information processing system 1.

The sequence illustrated in FIG. 7 is started when, for example, an operator receives the paper Y on which an event participant has drawn an image at an event site, sets the paper Y in the image reading apparatus (scanner) 55, and presses a button for starting to read the image.

First, the image reading apparatus (scanner) 55 outputs, to the PC 51, a read image on the front surface Y1 of the paper Y set in the image reading apparatus (scanner) 55 (Step S1).

Subsequently, the PC 51 performs a material image generation process of generating the material image that is obtained by extracting the image in the handwriting region Y10 included in the read image (Step S2).

The PC 51 constructs management information on the material image from a predetermined store code and the identification information in the identification region Y12 in the read image, and requests the content providing server 40 to register the material image in a place indicated by the management information (Step S3).

The content providing server 40 registers the material image in a unique path indicated by the management information on the basis of a registration request issued by the PC 51 (Step S4).

Meanwhile, in the configuration illustrated in the first embodiment, the read image that is output to the PC 51 at Step S1 is displayed, as an image to which a movement is added, by the image display system 50 on an as needed basis.

Further, in the sequence, a procedure of causing the image reading apparatus (scanner) 55 to output the read image on the paper one by one to the PC 51, and causing the PC 51 to register the read image of the paper one by one every time the read image is received (Step S2 and Step S3) is repeatedly performed. However, a part or whole of the registration procedure may be performed collectively after a predetermined number of read images are accumulated or at predetermined time intervals.

Furthermore, in this example, as one example, the operator starts to read the image by pressing an image read start button every time the operator sets the single paper Y, on which the event participant has drawn the image, in the image reading apparatus (scanner) 55. However, if the image reading apparatus (scanner) 55 includes an auto document feeder (ADF), it may be possible to perform continuous reading of a plurality of pieces of the paper Y by pressing the image read start button once after setting the plurality of pieces of the paper Y.

Modified Image Generation Process

Next, a modified image generation process of generating a modified image by adding an additional component, such as a motion or decoration, to a material image by causing the terminal device 20 to access the content providing server 40 in the information processing system 1 will be described below.

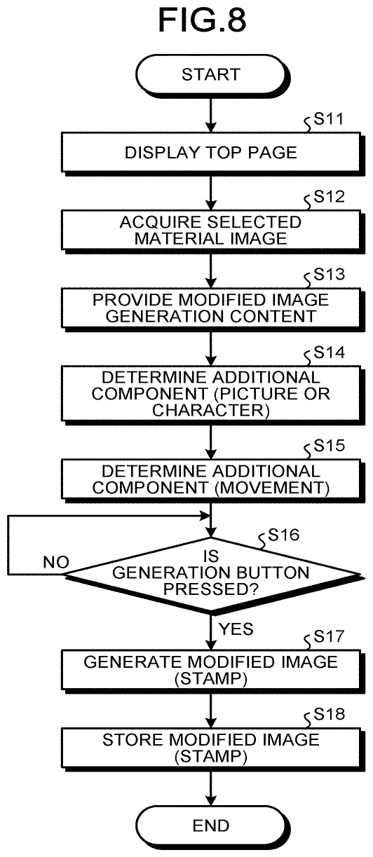

FIG. 8 is a flowchart illustrating the flow of the modified image generation process performed by the content providing server 40.

First, if the terminal device 20 activates the Web browser in response to operation performed by a user, the content providing server 40 displays a top page P1 on the display 418 of the terminal device 20 (Step S11).

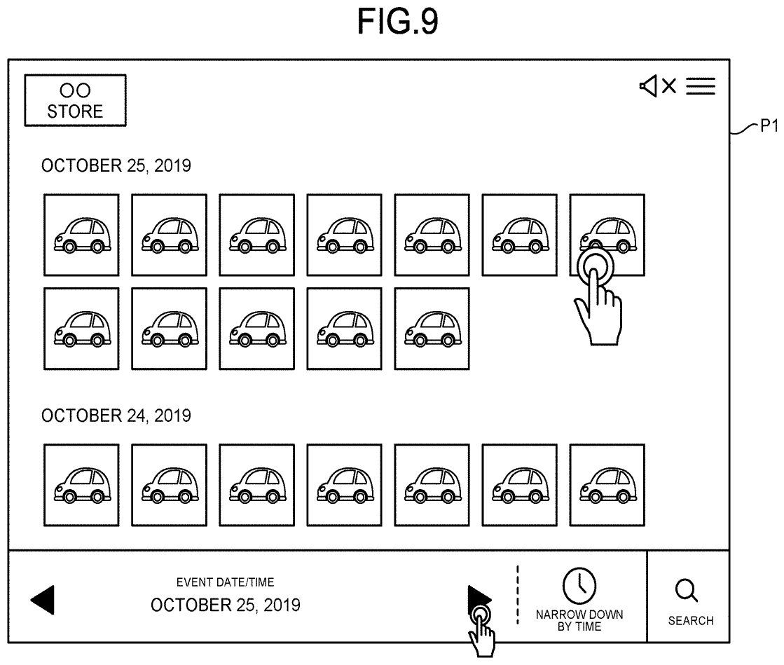

Here, FIG. 9 is a diagram illustrating an example of the top page P1. As illustrated in FIG. 9, a list of thumbnails of material images that are registered in the content providing server 40 is displayed on the top page P1 that is displayed on the display 418 of the terminal device 20.

A participant selects a desired material image from the list of the thumbnails of the material images displayed on the top page P1 via the touch panel 421.

Meanwhile, the list of the material images displayed on the top page P1 may be sorted by stores or sorted by date at which events are held. Further, it may be possible to display, when a participant inputs identification information, only a material image associated with the identification information on the top page P1 that is displayed on the display 418 of the terminal device 20.

The acquiring unit 101 of the content providing server 40 acquires a desired material image that is selected by the terminal device 20 (Step S12).

Subsequently, the providing unit 102 of the content providing server 40 provides a modified image generation content (Web page), by which the additional component, such as a motion or decoration, can be added to the material image, to the terminal device 20 and displays the modified image generation content on the display 418 (Step S13).

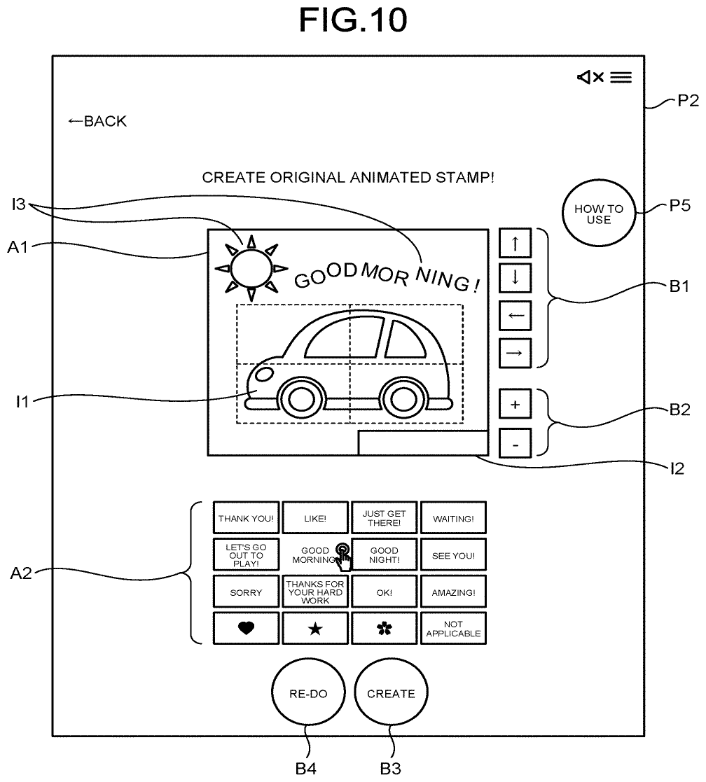

Here, FIG. 10 is a diagram illustrating an example of a modified image generation content P2. As illustrated in FIG. 10, a modified image generation area A1, an additional component area A2, a position adjustment button B1, a size adjustment button B2, a generation button B3, a re-do button B4, a usage button B5, and the like are displayed in the modified image generation content P2 that is displayed on the display 418 of the terminal device 20.

A selected material image I1 is displayed in the modified image generation area A1. Further, a predetermined image (additional component) 12, such as a logo, an event name, or a hashtag, which is set in advance is displayed in the modified image generation area A1.

The participant adjusts a position of the material image I1 within a range of the modified image generation area A1 by using the position adjustment button B1 via the touch panel 421. Further, the participant adjusts a size of the material image I1 within the range of the modified image generation area A1 by using the size adjustment button B2 via the touch panel 421.

The additional component area A2 is an area for selecting various additional components. The additional components that are registered in advance are displayed in the additional component area A2. The additional components in this example may be pictures for decorating the material image or characters. Further, the “characters” include text data of the title of the picture that is written in handwriting in the region Y11.

The participant selects a desired additional component from among the additional components in the additional component area A2 via the touch panel 421.

The determining unit 103 of the content providing server 40 determines that a selected additional component 13 is to be synthesized in the modified image generation area A1 (Step S14). Meanwhile, the content providing server 40 may change a background of the modified image generation area A1 in accordance with the selected additional component (a picture or a character).

Further, the determining unit 103 of the content providing server 40 determines an additional component (movement) that is to be added to the material image I1 displayed in the modified image generation area A1 (Step S15). Meanwhile, the determining unit 103 of the content providing server 40 may also add a movement to the additional component (picture or character) 13 that is selected at Step S14. For example, the content providing server 40 randomly adds one of the following multiple movements that are stored.

1. jump

2. sway

3. rotate

4. run

Moreover, the determining unit 103 of the content providing server 40 may determine a to-be-added movement on the basis of feature data that is extracted from the material image I1 as described in Japanese Unexamined Patent Application Publication No. 2016-177595 as described above, for example. Furthermore, the determining unit 103 of the content providing server 40 may determine a motion for the material image I1 on the basis of the identification information for identifying the paper Y.

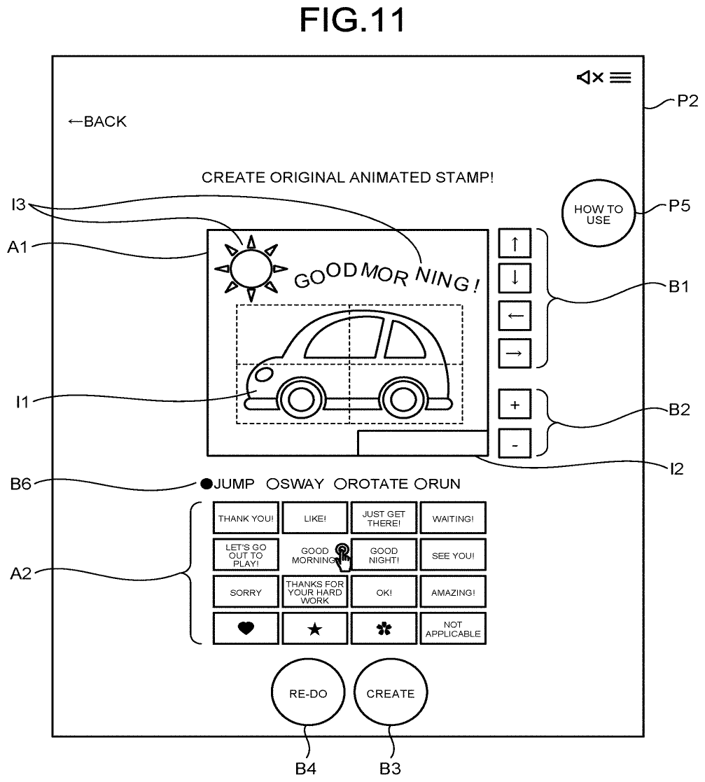

Here, FIG. 11 is a diagram illustrating another example of the modified image generation content P2. As illustrated in FIG. 11, it may be possible to display a radio button B6 for selecting a movement for the material image I1, in the modified image generation content P2 that is displayed on the display 418 of the terminal device 20.

Thus, by using the modified image generation content (Web page) P2, the participant is able to move the material image I1 in the determined a movement or decorate a periphery of the material image I1 with the additional component (picture or character) 13.

If modification on the material image I1 is completed, the participant presses the generation button B3 via the touch panel 421. Meanwhile, if the participant re-does the modification on the material image I1, the participant presses the re-do button B4 via the touch panel 421. Further, if the participant does not know how to modify the material image I1, the participant presses the usage button B5 via the touch panel 421.

If the generation button B3 is pressed (Yes at Step S16), the generating unit 104 of the content providing server 40 generates a modified image (stamp) in which the additional component 13, such as a movement or decoration, is added to the material image I1 (Step S17).

Subsequently, the storage unit 105 of the content providing server 40 stores the modified image (stamp) in a storage destination, such as a camera roll, formed in the EEPROM 404 of the terminal device 20 (Step S18). The modified image is stored in the form of an animated GIF or a still image.

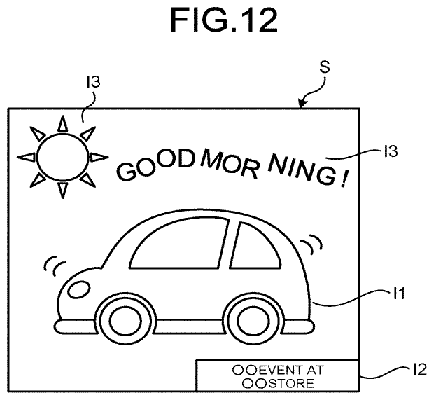

Here, FIG. 12 is a diagram illustrating an example of a modified image (stamp) S. As illustrated in FIG. 12, the modified image (stamp) S is an image in which the additional component 13, such as a movement or decoration, is added to the material image I1.

Meanwhile, the participant is able to accept selection of a social networking service (SNS), in which the modified image (stamp) S is to be shared, and upload the modified image (stamp) S by displaying a shared screen for the modified image (stamp) S that is stored in the camera roll formed in the EEPROM 404 of the terminal device 20.

As described above, according to the first embodiment, it is possible to generate a modified image in which the additional component, such as a movement or decoration, is added to the material image that is based on the picture drawn by the participant, so that even after the event, it is possible to provide an opportunity to have entertainment based on the picture drawn by the participant anytime, anywhere, and any number of times.

### Second Embodiment

A second embodiment will be described below.

The second embodiment is different from the first embodiment in that a movement of a material image is set by using dedicated paper. In the description of the second embodiment below, explanation on the same components as those of the first embodiment will be omitted, and differences from the first embodiment will be described.

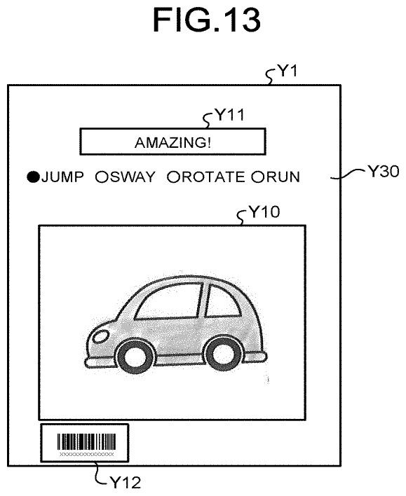

FIG. 13 is a diagram illustrating an example of layout in paper according to the second embodiment. As illustrated in FIG. 13, a movement selection region Y30 for determining a movement in order to add a three-dimensional movement as display information A to a material image is arranged in the paper Y, in addition to the components as described above with reference to FIGS. 3A to 3D. For example, a participant selects one of the following multiple movements.

1. jump

2. sway

3. rotate

4. run

The PC 51 analyzes the movement selection region Y30 in the read image of the picture drawn by the participant, and generates movement data based on the analyzed movement. The PC 51 registers the movement data that is an image analysis result in the DB 53. Further, the PC 51 transmits the material image, the text data, and the movement data that are extracted from the read image of the picture drawn on the paper Y and registered in the DB 53 to the content providing server 40 at a predetermined timing.

Then, at Step S15 illustrated in FIG. 8, the determining unit 103 of the content providing server 40 determines a movement that is to be added to the material image displayed in the modified image generation area A1, on the basis of the movement data.

According to the second embodiment as described above, it is possible to cause the modified image (stamp), in which the additional component, such as a movement or decoration, is added to the material image, to move in the same manner as in the image display system 50 at the event site.

Each of the functions of the embodiments as described above can be implemented by one or more processing circuits. Here, the “processing circuit” in this specification includes various devices; for example, a processor, such as a processor implemented by an electronic circuit, that is programmed to execute each of functions by software, an application specific integrated circuit (ASIC), a digital signal processor (DSP), a field programmable gate array (FPGA), or a conventional circuit module that are designed to execute each of the functions as described above.

A group of apparatuses described in the embodiments merely indicates one of multiple computing environments for implementing the embodiments disclosed in this specification. In some embodiments, the content providing server 40 includes a plurality of computing devices, such as a server cluster. The plurality of computing devices are configured to perform communication with one another via a communication link of an arbitrary type including a network, a shared memory, and the like, and perform processes disclosed in this specification.

According to an aspect of the present invention, it is possible to provide an opportunity to have entertainment based on a picture drawn by a participant regardless of time, place, and the number of times even after an event.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing apparatus comprising circuitry configured to:
determine an additional component to be added to a material image drawn on a medium;
generate a modified image in which the determined additional component is added to the material image; and
store the generated modified image.

2. The information processing apparatus according to claim 1, wherein the additional component is configured to add, to the material image, a motion for the material image.

3. The information processing apparatus according to claim 1, wherein the additional component includes a predetermined image set in advance and is further configured to add a motion to the predetermined image.

4. The information processing apparatus according to claim 1, wherein the circuitry is configured to determine a motion for the material image based on an analysis result on the material image.

5. The information processing apparatus according to claim 1, wherein the circuitry is configured to determine a motion for the material image based on predetermined identification information on the medium.

6. The information processing apparatus according to claim 1, wherein the circuitry is configured to determine a motion for the material image in accordance with selection from a plurality of motions determined in advance.

7. The information processing apparatus according to claim 3, wherein the predetermined image includes any of a logo, an event name, and a hashtag.

8. The information processing apparatus according to claim 1, wherein
the material image includes a character string written in a predetermined region on the medium, and
the character string constitutes the additional component.

9. An information processing method performed by an information processing apparatus, the information processing method comprising:
determining an additional component to be added to a material image drawn on a medium;
generating a modified image in which the additional component determined at the determining is added to the material image; and
storing the modified image generated at the generating.

10. An information processing system comprising circuitry configured to:
acquire a material image drawn on a medium;
determine an additional image to be added to the material image;
generate a modified image in which the determined additional component is added to the material image; and
store the generated modified image in a predetermined terminal.
